(19) United States
(12) Patent Application Publication
(10) Pub. No.: US 2025/0180837 A1
(43) Pub. Date: Jun. 5, 2025

(54) OPTICAL CONNECTOR

(71) Applicant: MITSUBISHI HEAVY INDUSTRIES, LTD., Tokyo (JP)

(72) Inventors: Saneyuki GOYA, Tokyo (JP); Yasuyuki FUJIYA, Tokyo (JP); Takeshi SATAKE, Kyoto (JP); Masaaki TANIGUCHI, Kyoto (JP)

(21) Appl. No.: 18/696,134

(22) PCT Filed: Sep. 27, 2022
(86) PCT No.: PCT/JP2022/035863

§ 371 Date: Feb. 19, 2025

(30) Foreign Application Priority Data
Oct. 1, 2021 (JP) 2021-162870

(51) Int. Cl. G02B 6/42

(52) U.S. Cl. CPC G02B 6/4268; G02B 6/4206

(57) ABSTRACT

Provided is an optical connector including: an optical fiber; an inner sleeve; an outer sleeve; a light guide member; a supply mechanism configured to supply a cooling medium to an inflow space inside the inner sleeve; and a discharge mechanism configured to discharge the cooling medium from an outflow space between the inner sleeve and the outer sleeve. The optical fiber has a core part and a coating part. The core part is coated with the coating part in a coated region and is not coated with the coating part in an uncoated region. The supply mechanism supplies the cooling medium to the inflow space in the coated region, and the inner sleeve has, in the uncoated region, a communication hole configured to provide communication between the inflow space and the outflow space.

### TECHNICAL FIELD

The present disclosure relates to an optical connector.

### BACKGROUND ART

Optical connectors for connecting an optical fiber and a laser machining device to each other when transmitting a laser beam to the laser machining device through the optical fiber are conventionally known (for example, see Patent Literature 1). An optical connector disclosed in Patent Literature 1 includes a first sleeve supported on an inner face of a circular cylindrical housing and a second sleeve supported on an inner face of the first sleeve, and an optical fiber is arranged inside the second sleeve.

In Patent Literature 1, cooling water is supplied to a cooling water storage part located between the first sleeve and the second sleeve, and the cooling water is guided in the axis direction by the second sleeve and turned back at the tip of the second sleeve. The cooling water turned back at the tip of the second sleeve flows through both a first cooling water storage part between the first sleeve and the second sleeve and the inside of the second sleeve and is then discharged from the cooling water storage part.

### CITATION LIST

### Patent Literature

[PTL 1]
Japanese Patent Application Laid-Open No. 2020-8668

### SUMMARY OF INVENTION

### Technical Problem

The inventors have studied the heat generation state of the optical connector and thus found that the amount of heat generation is particularly large in the boundary portion between a coated region in which the core part of the optical fiber is coated with a coating part and an uncoated region in which the core part of the optical fiber is not coated with the coating part. In the optical connector of Patent Literature 1, although the coating part at the boundary position between the coated region and the uncoated region is cooled by the cooling water, there has been room for improvement in the cooling efficiency.

In the optical connector in Patent Literature 1, the cooling water supplied to the cooling water storage part between the first sleeve and the second sleeve is guided in the axis direction by the second sleeve and turned back at the tip of the second sleeve and then reaches a coating part at the boundary position between the coated region and the uncoated region. Since the cooling water is heated before reaching the coating part at the boundary position between the coated region and the uncoated region, there has been room for improvement in the cooling efficiency of the coating part at the boundary position.

The present disclosure has been made in view of such circumstances and intends to provide an optical connector with improved cooling efficiency of a coating part at the boundary position between a coated region in which a core part of an optical fiber is coated with the coating part and an uncoated region in which the core part of the optical fiber is not coated with the coating part.

### Solution to Problem

An optical connector according to one aspect of the present disclosure includes: an optical fiber arranged along an axis; an inner sleeve formed in a circular cylindrical shape along the axis and configured to hold the optical fiber on an inner circumferential side; an outer sleeve formed in a circular cylindrical shape along the axis and configured to hold the inner sleeve on an inner circumferential side; a light guide member having a first end face and a second end face and configured to guide a laser beam from the first end face to the second end face, the laser beam emitted from a light source entering the first end face, and the second end face being joined to an incident end face of the optical fiber; a supply mechanism configured to supply a cooling medium to an inflow space inside the inner sleeve; and a discharge mechanism configured to discharge the cooling medium from an outflow space between the inner sleeve and the outer sleeve, the optical fiber has a core part configured to transmit the laser beam and a coating part covering the core part, the core part is coated with the coating part in a coated region along the axis and is not coated with the coating part in an uncoated region between the coated region and the incident end face, the supply mechanism supplies the cooling medium to the inflow space in the coated region, and the inner sleeve has, in the uncoated region, a communication hole configured to provide communication between the inflow space and the outflow space.

### Advantageous Effects of Invention

According to the present disclosure, it is possible to provide an optical connector with improved cooling efficiency of the boundary portion between a coated region in which a core part of an optical fiber is coated with a coating part and an uncoated region in which the core part of the optical fiber is not coated with the coating part.

### BRIEF DESCRIPTION OF DRAWINGS

FIG. 1 is a longitudinal sectional view illustrating an optical connector according to one embodiment of the present disclosure.

FIG. 2 is an arrow A-A sectional view of the optical connector illustrated in FIG. 1.

FIG. 3 is a partial enlarged view of a part B illustrated in FIG. 1.

FIG. 4 is a block diagram illustrating a control configuration of the optical connector of the present embodiment.

FIG. 5 is a transverse sectional view illustrating a modified example of an inner sleeve.

### DESCRIPTION OF EMBODIMENTS

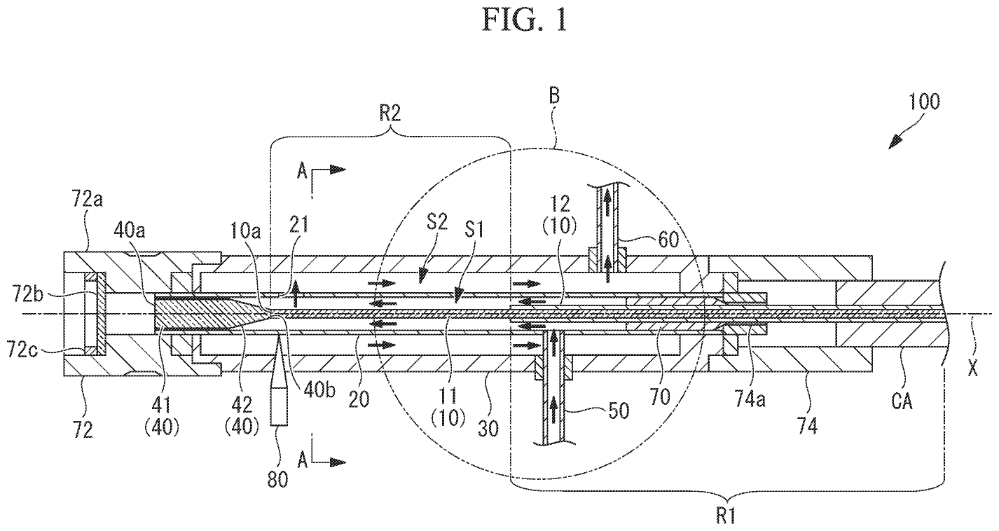

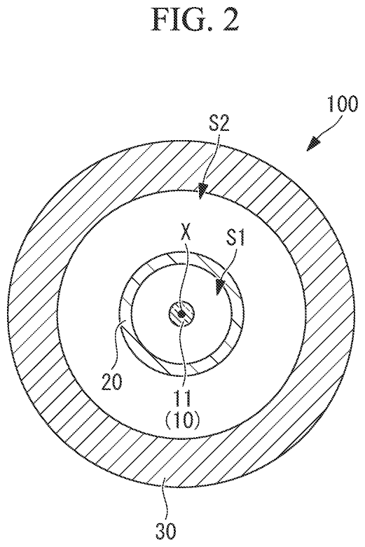

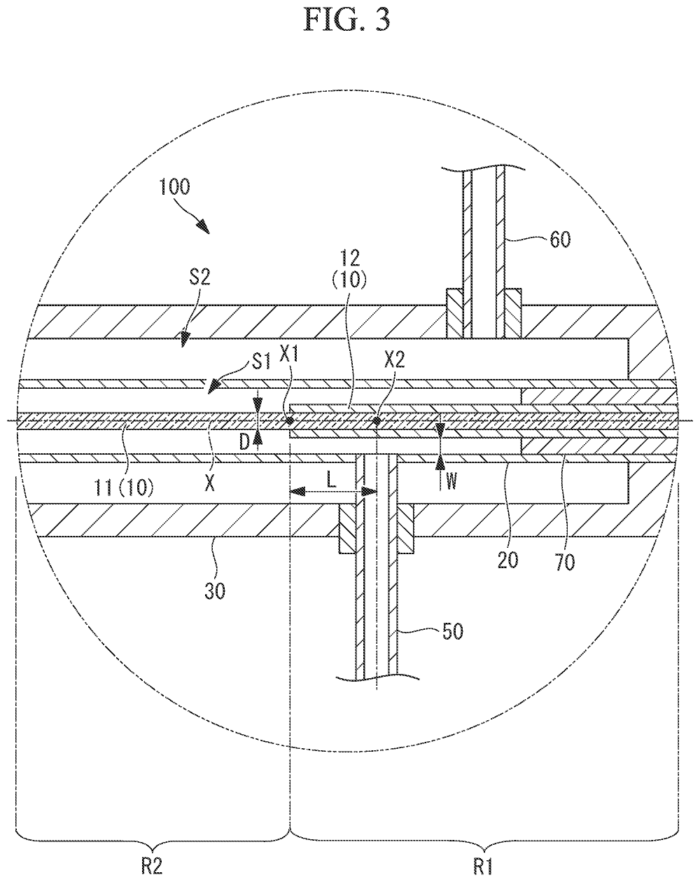

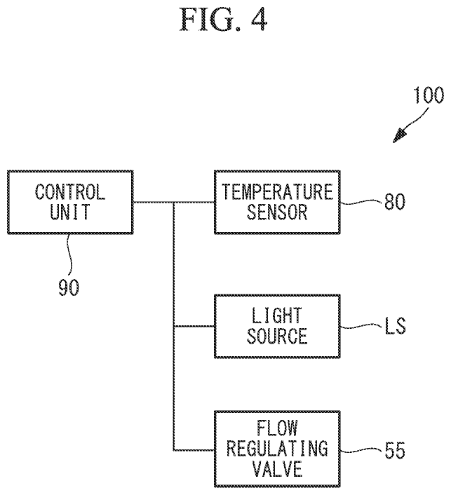

An optical connector 100 according to one embodiment of the present disclosure will be described below with reference to the drawings. FIG. 1 is a longitudinal sectional view illustrating the optical connector 100 according to the present embodiment. FIG. 2 is an arrow A-A sectional view of the optical connector illustrated in FIG. 1. FIG. 3 is a partial enlarged view of a part B illustrated in FIG. 1. FIG. 4 is a block diagram illustrating a control configuration of the optical connector 100 according to the present embodiment. Arrows illustrated in FIG. 1 represent flow directions of a cooling medium.

The optical connector 100 of the present embodiment is a device for connecting an optical fiber 10 and a laser machining device (not illustrated) to each other when transmitting a laser beam, which is emitted from a light source LS to the laser machining device through the optical fiber 10. As illustrated in FIG. 1 and FIG. 3, the optical connector 100 includes the optical fiber 10, an inner sleeve 20, an outer sleeve 30, a light guide member 40, a supply mechanism 50, a flow regulating valve (supply rate regulating unit) 55, a discharge mechanism (cooling mechanism) 60, a holding member 70, a front fixing sleeve 72, a rear fixing sleeve 74, a temperature sensor (temperature detection unit) 80, and a control unit (output adjustment unit) 90.

The optical fiber 10 is a member arranged along the axis X and configured to transmit a laser beam entering the incident end face 10a from the light source LS via the light guide member 40. The optical fiber 10 has a core part 11 configured to transmit a laser beam and having a circular cross section orthogonal to the axis X and a coating part 12 covering the outer circumferential face of the core part 11. The output of the laser beam emitted by the light source LS is preferably 1 W or higher, more preferably 1 kW or higher.

The optical fiber used herein is effective to both a solid type fiber and a hollowed photonic crystal fiber (PCF) and, in particular, significantly effective to fibers capable of transmitting high quality laser, such as high-power and single mode fiber laser.

The core part 11 is a member in which a silica glass clad is provided outside a silica glass core. The coating part 12 is formed of a UV curable resin such as polyimide. As illustrated in FIG. 1, the core part 11 is coated with the coating part 12 in a coated region R1 along the axis X. However, the core part 11 is not coated with the coating part 12 in an uncoated region R2 along the axis X.

The inner sleeve 20 is a member formed in a circular cylindrical shape along the axis X and configured to hold the optical fiber 10 on the inner circumferential side of the inner sleeve 20. The inner sleeve 20 is formed of a metal material having high thermal conductivity, such as brass. The inside of the inner sleeve 20 is an inflow space S1 into which a cooling medium such as cooling water flows through the supply mechanism 50. As shown in FIG. 2, the inflow space S1 is a space formed annularly about the axis X.

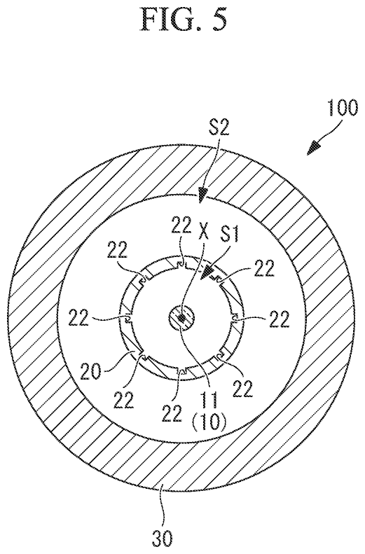

The inner circumferential face of the inner sleeve 20 illustrated in FIG. 2 is formed in a circular shape in sectional view, but other forms may be employed. For example, as illustrated in FIG. 5, a plurality of grooves 22 arranged at intervals in the circumference direction about the axis X may be formed in the inner circumferential face of the inner sleeve 20. FIG. 5 is a transverse sectional view illustrating a modified example of the inner sleeve 20. The grooves 22 illustrated in FIG. 5 are formed in a straight line so as to extend along the axis X. According to the inner sleeve 20 where the grooves 22 are formed in the inner circumferential face, the cooling medium that has flown into the inflow space S1 can be suitably adjusted to flow toward a communication hole 21 along the axis X.

The outer sleeve 30 is a member formed in a circular cylindrical shape along the axis X and configured to hold the inner sleeve 20 on the inner circumferential side of the outer sleeve 30. The outer sleeve 30 is formed of a copper alloy, brass, an aluminum alloy, or the like having excellent thermal conductivity. An outflow space S2 that guides a cooling medium flowing out of the discharge mechanism 60 is defined between the inner sleeve 20 and the outer sleeve 30. As shown in FIG. 2, the outflow space S2 is a space formed annularly about the axis X.

The inner sleeve 20 has a communication hole 21 that provides communication between the inflow space S1 and the outflow space S2 in the uncoated region R2. As illustrated in FIG. 1, the communication hole 21 is formed near the position at which the incident end face 10a of the optical fiber 10 and the second end face 40b of the light guide member 40 are joined (fused) to each other. The communication hole 21 may be formed in only one portion illustrated in FIG. 1 or may be formed in multiple portions in the circumferential direction about the axis X.

The light guide member 40 is a member that guides a laser beam to the incident end face 10a of the optical fiber 10 in which this laser beam is emitted along the axis X from the light source LS. The light guide member 40 has a first end face 40a that a laser beam emitted from the light source LS enters and a second end face 40b fused and thereby joined to the incident end face 10a of the optical fiber 10. The light guide member 40 guides a laser beam from the first end face 40a to the second end face 40b.

The light guide member 40 is a member in which a first member 41 formed in a columnar shape and a second member 42 formed in a substantially cone shape are integrally formed. For example, the light guide member 40 is formed of quartz. As illustrated in FIG. 1, the outer circumferential face of the first member 41 is joined to the inner circumferential face of a front fixing sleeve 72 side (one end side) of the inner sleeve 20 via an adhesive agent.

The supply mechanism 50 is a mechanism that supplies a cooling medium to the inflow space S1 in the coated region R1. The supply mechanism 50 is a tube body that causes a cooling medium supplied from a supply source (not illustrated) via the flow regulating valve 55 to flow therethrough. The supply mechanism 50 penetrates through the outer sleeve 30 and communicates with the inflow space S1 inside the inner sleeve 20.

As illustrated in FIG. 3, the distance along the axis X between the boundary position X1 between the coated region R1 and the uncoated region R2 and an inflow position X2 at which the supply mechanism 50 allows the cooling medium to flow into the inflow space S1 is defined as L. Further, an outer diameter of the core part 11 is defined as D. Then, the distance L and the outer diameter D are set to meet Equation (1) below.

$$1 \leq L / D \leq 200 \qquad ( 1 )$$

Further, the distance L and the outer diameter D are more preferably set to meet Equation (2) below.

$$10 \leq L / D \leq 100 \qquad ( 2 )$$

As illustrated in FIG. 3, the width between the outer circumferential face of the coating part 12 and the inner circumferential face of the inner sleeve 20 is defined as W in the radial direction orthogonal to the axis X. Further, the width W and the outer diameter D are set to meet Equation (3) below.

$$1 \leq W / D \leq 50 \qquad ( 3 )$$

The flow regulating valve 55 is a valve body whose opening is adjusted in accordance with a control signal transmitted from the control unit 90. The flow regulating valve 55 guides a cooling medium from the supply source to the supply mechanism 50 at a supply rate in accordance with the opening.

The discharge mechanism 60 is a mechanism that discharges a cooling medium from the outflow space S2 to outside in the coated region R1 in which this cooling medium has flown into the inflow space S1 from the supply mechanism 50 and been guided to the outflow space S2 through the communication hole 21. The discharge mechanism is a tube body that causes a cooling medium to flow from the outflow space S2 to outside. The discharge mechanism 60 penetrates through the outer sleeve 30 and communicates with the outflow space S2.

The holding member 70 is a member formed in a columnar shape along the axis X and configured to hold the optical fiber 10. As illustrated in FIG. 1, the outer circumferential face of the holding member 70 is fixed to the inner circumferential face on a rear fixing sleeve 74 side (the other end side) of the inner sleeve 20. The holding member 70 is attached while being abutted against the rear fixing sleeve 74.

A seal material 74a made of a silicone resin, for example, is filled so as to seal a portion where the holding member 70 and the rear fixing sleeve 74 are abutted against each other. Further, as described above, the outer circumferential face of the first member 41 is joined to the inner circumferential face of the front fixing sleeve 72 side (one end side) of the inner sleeve 20 via an adhesive agent. Accordingly, the inflow space S1 is a space sealed by the light guide member 40 and the holding member 70.

The front fixing sleeve 72 is a member attached to the end on the light source LS side of the inner sleeve 20 and the outer sleeve 30 and formed in a circular cylindrical shape along the axis X. The front fixing sleeve 72 has a main body 72a, a window member 72b formed of quarts, and a fixing member 72c for fixing the window member 72b to the main body 72a. The laser beam emitted from the light source LS transmits through the window member 72b and is then guided to the first end face 40a of the light guide member 40.

The rear fixing sleeve 74 is a member attached to the end on the opposite side of the light source LS of the inner sleeve 20 and the outer sleeve 30 and formed in a circular cylindrical shape along the axis X. The inner sleeve 20 and the outer sleeve 30 are attached to the light source LS side of the rear fixing sleeve 74. A fiber cable CA is attached to the opposite side of the light source LS of the rear fixing sleeve 74.

The temperature sensor 80 is a device that determines a temperature of a cooling medium that has passed through a boundary position between the coated region R1 and the uncoated region R2. The temperature sensor 80 determines the temperature of the inner sleeve 20 near a position at which the incident end face 10a of the optical fiber 10 and the second end face 40b of the light guide member 40 are joined (fused) to each other. By determining the temperature of the inner sleeve 20, the temperature sensor 80 can determine the temperature of the cooling medium passing through the position at which the incident end face 10a of the optical fiber 10 and the second end face 40b of the light guide member 40 are fused to each other.

The control unit 90 is a device that adjusts the flow regulating valve 55 and the output of a laser beam of the light source LS in accordance with the temperature determined by the temperature sensor 80. The control unit 90 controls the flow regulating valve 55 so as to increase the opening of the flow regulating valve 55 when the temperature determined by the temperature sensor 80 is higher than a target temperature. Further, the control unit 90 controls the flow regulating valve 55 so as to reduce the opening of the flow regulating valve 55 when the temperature determined by the temperature sensor 80 is lower than a target temperature.

The control unit 90 adjusts the light source LS so as to stop the output of the laser beam output from the light source LS when the temperature determined by the temperature sensor 80 is higher than a predetermined threshold temperature. By stopping the output of the laser beam, it is possible to prevent the optical connector 100 from being maintained at a temperature higher than the threshold temperature and damaged.

Next, the flow of the cooling medium flowing through inside of the optical connector 100 of the present embodiment will be described.

The cooling medium supplied from the supply source is supplied to the inflow space S1 of the coated region R1 through the supply mechanism 50 with the supply rate being regulated by the flow regulating valve 55. The cooling medium supplied to the inflow space S1 of the coated region R1 flows through along the axis X from the coated region R1 toward the uncoated region R2 and passes through the boundary position X1 between the coated region R1 and the uncoated region R2. The cooling medium passing through the boundary position X1 cools the coating part 12 near the boundary position X1.

The cooling medium that has passed through the boundary position X1 flows through along the axis X toward the light guide member 40 and is guided from the communication hole 21 to the outflow space S2 of the uncoated region R2. The cooling medium that has flown through the inflow space S1 from the coated region R1 toward the uncoated region R2 turns back at the communication hole 21 and flows through the outflow space S2 in the reverse direction from the uncoated region R2 to the coated region R1. The cooling medium that has passed through the boundary position between the uncoated region R2 and the coated region R1 is discharged from the outflow space S2 to outside through the discharge mechanism 60.

The optical connector 100 of the present embodiment described above achieves the following advantageous effects.

According to the optical connector 100 of the present embodiment, the optical fiber 10 is held on the inner circumferential side of the inner sleeve 20, and the inner sleeve 20 is held on the inner circumferential side of the outer sleeve 30. The optical fiber 10 is coated with the coating part 12 in the coated region R1 and is not coated with the coating part 12 in the uncoated region R2. The laser beam entering the first end face 40a of the light guide member 40 and guided to the second end face 40b enters the incident end face 10a of the optical fiber 10, passes through the uncoated region R2, and reaches the coated region R1.

When the laser beam passes through the uncoated region R2, a substantial part of the laser beam is mostly reflected by the core part 11 without transmitting therethrough because of relatively a large difference in refractive index between the core part 11 (made of quarts glass and having a refractive index of about 1.5 in 1 μm band) and the cooling medium (having a refractive index of about 1.3 in 1 μm band when the cooling medium is water).

In contrast, the refractive index of the coating part 12 is about 1.4, which is a numerical value between those of the core part 11 and the cooling medium, and the difference in refractive index between the core part 11 and the coating part 12 is relatively small. Thus, when the laser beam passes through the coated region R1, a part of the laser beam transmits through the coating part 12 and heats the coating part 12. Therefore, the coating part 12 generates heat at the boundary position between the uncoated region R2 and the coated region R1. Further, since the coating part 12 has inferior heat resistance compared to the core part 11, burn-out of the coating part 12 is likely to occur when the temperature thereof increases.

According to the optical connector 100 of the present embodiment, the supply mechanism 50 supplies the cooling medium to the inflow space S1 inside the inner sleeve 20 in the coated region R1. Further, the inner sleeve 20 has the communication hole 21 for communicating the inflow space S1 and the outflow space S2 with each other in the uncoated region R2. Thus, the cooling medium supplied by the supply mechanism 50 moves from the coated region R1 toward the communication hole 21 provided in the uncoated region R2 immediately after flowing into the inflow space S1 and cools the coating part 12 at the boundary position X1 between the uncoated region R2 and the coated region R1. Thus, the cooling efficiency of the coating part 12 at the boundary position X1 between the uncoated region R2 and the coated region R1 is improved.

Further, according to the optical connector 100 of the present embodiment, one end side of the inner sleeve 20 is closed by the light guide member 40, the other end side of the inner sleeve 20 is closed by the holding member 70, and the sealed inflow space S1 is formed. Since the inflow space S1 is sealed, the entire cooling medium flowing into the inflow space S1 from the supply mechanism 50 is guided to the outflow space S2 via the communication hole 21. Since a uniform flow from the supply mechanism 50 toward the communication hole 21 is formed, the cooling medium flows through the inflow space S1 without stagnation and can efficiently cool the coating part 12 at the boundary position.

Further, according to the optical connector 100 of the present embodiment, since the discharge mechanism 60 discharges the cooling medium from the outflow space S2 in the coated region R1, the cooling medium that has flown in the direction from the supply mechanism 50 to the communication hole 21 is turned back at the communication hole 21 and flows in the opposite direction from the communication hole 21 to the discharge mechanism 60. Since the cooling medium flows through a long flow channel turning back at the communication hole 21 without stagnation, it is possible to effectively cool each part of the optical connector 100 including the coating part 12 at the boundary position.

Further, according to the optical connector 100 of the present embodiment, since the grooves 22 extending along the axis X are formed in the inner circumferential face of the inner sleeve 20, the cooling medium that has flown into the inflow space S1 can be suitably adjusted to flow toward the communication hole 21 along the axis X.

Further, according to the optical connector 100 of the present embodiment, by adjusting the supply amount of the cooling medium supplied from the supply mechanism 50 to the inflow space S1 in accordance with the temperature of the cooling medium that has cooled the coating part 12 at the boundary position X1 between the coated region R1 and the uncoated region R2 at which the amount of heat generation is large, it is possible to suitably cool the coating part 12 at the boundary position in accordance with the amount of heat generation.

Further, according to the optical connector 100 of the present embodiment, by adjusting the output of a laser beam output from the light source LS in accordance with the temperature of the cooling medium that has cooled the coating part 12 at the boundary position between the coated region R1 and the uncoated region R2 at which the amount of heat generation is large, it is possible to suitably cool the coating part 12 at the boundary position in accordance with the amount of heat generation.

Further, according to the optical connector 100 of the present embodiment, the distance L and the outer diameter D are set to meet 1≤L/D≤200 (more preferably 10≤L/D≤100), where the distance along the axis X between the boundary position X1 between the coated region R1 and the uncoated region R2 and the inflow position X2 at which the supply mechanism 50 allows the cooling medium to flow into the inflow space S1 is defined as L and the outer diameter of the core part 11 is defined as D. Since this allows the cooling medium to flow into a portion near the boundary position X1 between the uncoated region R2 and the coated region R1, the cooling efficiency of the coating part 12 is improved.

The optical connector according to the present embodiment as described above is understood as follows, for example.

An optical connector (100) according to the present disclosure includes: an optical fiber (10) arranged along an axis (X); an inner sleeve (20) formed in a circular cylindrical shape along the axis and configured to hold the optical fiber on an inner circumferential side; an outer sleeve (30) formed in a circular cylindrical shape along the axis and configured to hold the inner sleeve on an inner circumferential side; a light guide member (40) having a first end face (41) and a second end face and configured to guide a laser beam from the first end face to the second end face, the laser beam emitted from a light source entering the first end face, and the second end face being joined to an incident end face (10a) of the optical fiber; a supply mechanism (50) configured to supply a cooling medium to an inflow space (S1) inside the inner sleeve; and a discharge mechanism (60) configured to discharge the cooling medium from an outflow space (S2) between the inner sleeve and the outer sleeve, the optical fiber has a core part (11) configured to transmit the laser beam and a coating part (12) covering the core part, the core part is coated with the coating part in a coated region (R1) along the axis and is not coated with the coating part in an uncoated region (R2) between the coated region and the incident end face, the supply mechanism supplies the cooling medium to the inflow space in the coated region, and the inner sleeve has, in the uncoated region, a communication hole (21) configured to provide communication between the inflow space and the outflow space.

According to the optical connector of the present disclosure, the optical fiber is held on the inner circumferential side of the inner sleeve, and the inner sleeve is held on the inner circumferential side of the outer sleeve. The optical fiber is coated with the coating part in the coated region and is not coated with the coating part in the uncoated region. The laser beam entering the first end face of the light guide member and guided to the second end face enters the incident end face of the optical fiber, passes through the uncoated region, and reaches the coated region.

When the laser beam passes through the uncoated region, a substantial part of the laser beam is mostly reflected by the core part without transmitting therethrough because of relatively a large difference in refractive index between the core part and the cooling medium. In contrast, the refractive index of the coating part is a numerical value between those of the core part and the cooling medium, and the difference in refractive index between the core part and the coating part is relatively small. Thus, when the laser beam passes through the coated region, a part of the laser beam transmits through the coating part and heats the coating part. Therefore, the coating part generates heat at the boundary position between the uncoated region and the coated region. Further, since the coating part has inferior heat resistance compared to the core part, burn-out of the coating part is likely to occur when the temperature thereof increases.

According to the optical connector of the present disclosure, the supply mechanism supplies the cooling medium to the inflow space inside the inner sleeve in the coated region. Further, the inner sleeve has the communication hole for communicating the inflow space and the outflow space with each other in the uncoated region. Thus, the cooling medium supplied by the supply mechanism moves from the coated region toward the communication hole provided in the uncoated region immediately after flowing into the inflow space and cools the coating part at the boundary position between the uncoated region and the coated region. Thus, the cooling efficiency of the coating part at the boundary position between the uncoated region and the coated region is improved.

The optical connector according to the present disclosure may be configured such that an outer circumferential face of the light guide member formed in a circular columnar shape along the axis is joined to an inner circumferential face on one end side of the inner sleeve, an outer circumferential face of a holding member (70) formed in a circular columnar shape along the axis and holding the optical fiber is joined to an inner circumferential face on the other end side of the inner sleeve, and the inflow space is a space sealed by the light guide member and the holding member.

According to the optical connector of the present configuration, one end side of the inner sleeve is closed by the light guide member, the other end side of the inner sleeve is closed by the holding member, and the sealed inflow space is formed. Since the inflow space is sealed, the entire cooling medium flowing into the inflow space from the supply mechanism is guided to the outflow space via the communication hole. Since a uniform flow from the supply mechanism toward the communication hole is formed, the cooling medium flows through the inflow space without stagnation and can efficiently cool the coating part at the boundary position.

The optical connector according to the present disclosure may be configured such that the discharge mechanism discharges the cooling medium from the outflow space in the coated region.

According to the optical connector of the present configuration, since the discharge mechanism discharges the cooling medium from the outflow space in the coated region, the cooling medium that has flown in the direction from the supply mechanism to the communication hole is turned back at the communication hole and flows in the opposite direction from the communication hole to the discharge mechanism. Since the cooling medium flows through a long flow channel turning back at the communication hole without stagnation, it is possible to effectively cool each part of the optical connector including the coating part at the boundary position.

The optical connector according to the present disclosure may be configured such that a groove (22) extending along the axis is formed in an inner circumferential face of the inner sleeve.

According to the optical connector of the present configuration, since the grooves extending along the axis are formed in the inner circumferential face of the inner sleeve, the cooling medium flowing into the inflow space can be suitably adjusted to flow toward the communication hole along the axis.

The optical connector according to the present disclosure may be configured such that a temperature detection unit (80) configured to determine a temperature of the cooling medium after passing through a boundary position between the coated region and the uncoated region; and a supply amount adjustment unit (55) configured to adjust a supply amount of the cooling medium supplied from the supply mechanism to the inflow space in accordance with the temperature of the cooling medium determined by the temperature detection unit are included.

According to the optical connector of the present configuration, by adjusting the supply amount of the cooling medium supplied from the supply mechanism to the inflow space in accordance with the temperature of the cooling medium that has cooled the coating part at the boundary position between the coated region and the uncoated region at which the amount of heat generation is large, it is possible to suitably cool the coating part at the boundary position in accordance with the amount of heat generation.

The optical connector according to the present disclosure may be configured to include: a temperature detection unit (80) configured to determine a temperature of the cooling medium after passing through a boundary position between the coated region and the uncoated region; and an output adjustment unit (90) configured to adjust output of the laser beam emitted from the light source in accordance with the temperature of the cooling medium determined by the temperature detection unit (80).

According to the optical connector of the present configuration, by adjusting the output of the laser beam output from the light source in accordance with the temperature of the cooling medium that has cooled the coating part at the boundary position between the coated region and the uncoated region at which the amount of heat generation is large, it is possible to suitably cool the coating part at the boundary position in accordance with the amount of heat generation.

The optical connector according to the present disclosure may be configured such that 1≤L/D≤200 is met, where the distance along the axis between a boundary position between the coated region and the uncoated region and an inflow position at which the supply mechanism allows the cooling medium to flow into the inflow space is defined as L and the outer diameter of the core part is defined as D. The configuration in which 10≤L/D≤100 is met is more preferably.

The distance L and the outer diameter D are set to meet 1≤L/D≤200 (more preferably 10≤L/D≤100). Since this allows the cooling medium to flow into a portion near the boundary position between the uncoated region and the coated region, the cooling efficiency of the coating part is improved.

### REFERENCE SIGNS LIST

10 optical fiber
10a incident end face
11 core part
12 coating part
20 inner sleeve
21 communication hole
22 groove
30 outer sleeve
40 light guide member
40a first end face
40b second end face
41 first member
42 second member
50 supply mechanism
55 flow regulating valve
60 discharge mechanism
70 holding member
72 front fixing sleeve
72a main body
72b window member
72c fixing member
74 rear fixing sleeve
74a seal material
80 temperature sensor
90 control unit
100 optical connector
CA fiber cable
D outer diameter
L distance
LS light source
R1 coated region
R2 uncoated region
S1 inflow space
S2 outflow space
X axis
X1 boundary position
X2 inflow position

1. An optical connector comprising:
an optical fiber arranged along an optical axis;
an inner sleeve formed in a circular cylindrical shape along the optical axis and configured to hold the optical fiber on an inner circumferential side;
an outer sleeve formed in a circular cylindrical shape along the optical axis and configured to hold the inner sleeve on an inner circumferential side;
a light guide member having a first end face and a second end face and configured to guide a laser beam from the first end face to the second end face, the laser beam emitted from a light source entering the first end face, and the second end face being joined to an incident end face of the optical fiber;
a supply mechanism configured to supply a cooling medium to an inflow space inside the inner sleeve; and
a discharge mechanism configured to discharge the cooling medium from an outflow space between the inner sleeve and the outer sleeve,
wherein the optical fiber has a core part configured to transmit the laser beam and a coating part covering the core part,
wherein the core part is coated with the coating part in a coated region along the optical axis and is not coated with the coating part in an uncoated region between the coated region and the incident end face,
wherein the supply mechanism supplies the cooling medium to the inflow space in the coated region, and
wherein the inner sleeve has, in the uncoated region, a communication hole configured to provide communication between the inflow space and the outflow space, the communication hole being formed in multiple portions in a circumferential direction about the optical axis,
wherein an outer circumferential face of the light guide member formed in a circular columnar shape along the optical axis is joined to an inner circumferential face on one end side of the inner sleeve,
wherein an outer circumferential face of a holding member formed in a circular columnar shape along the optical axis and holding the optical fiber is joined to an inner circumferential face on the other end side of the inner sleeve,
wherein one end side of the inner sleeve is closed by the light guide member and the other end side of the inner sleeve is closed by the holding member, and
wherein the inflow space is a space sealed by the light guide member and the holding member along a direction of the optical axis.

2. (canceled)

3. The optical connector according to claim 1, wherein the discharge mechanism discharges the cooling medium from the outflow space in the coated region.

4. The optical connector according to claim 1, wherein a groove extending along the optical axis is formed in an inner circumferential face of the inner sleeve.

5. The optical connector according to claim 1 further comprising:
a temperature detection unit configured to determine a temperature of the cooling medium after passing through a boundary position between the coated region and the uncoated region; and
a supply amount adjustment unit configured to adjust a supply amount of the cooling medium supplied from the supply mechanism to the inflow space in accordance with the temperature of the cooling medium determined by the temperature detection unit.

6. The optical connector according to claim 1 further comprising:
a temperature detection unit configured to determine a temperature of the cooling medium after passing through a boundary position between the coated region and the uncoated region; and
an output adjustment unit configured to adjust output of the laser beam emitted from the light source in accordance with the temperature of the cooling medium determined by the temperature detection unit.

7. The optical connector according to claim 1, wherein 1≤L/D≤200 is met, where the distance along the optical axis between a boundary position between the coated region and the uncoated region and an inflow position at which the supply mechanism allows the cooling medium to flow into the inflow space is defined as L and the outer diameter of the core part is defined as D.

8. The optical connector according to claim 7, wherein 10≤L/D≤100 is met.
